(19) United States
(12) Patent Application Publication
(10) Pub. No.: US 2018/0105326 A1
(43) Pub. Date: Apr. 19, 2018

(54) WIDE MOUTH CARRYOUT BAGS AND DISPENSING RACK

(71) Applicant: Jessica Tan, Harahan, LA (US)

(72) Inventor: Jessica Tan, Harahan, LA (US)

(21) Appl. No.: 15/297,156

(22) Filed: Oct. 19, 2016

(51) Int. Cl. B65D 33/08; B65D 33/00; B65D 33/14; B65D 30/20; A47F 9/04; B31B 23/00; B31B 19/16

(52) U.S. Cl. CPC B65D 33/08; B65D 33/001; B65D 33/14; B65D 31/10; B65D 33/007; B31B 2237/10; B31B 23/00; B31B 19/16; B31B 2219/141; B31B 2219/145; B31B 2237/60; A47F 9/042

(57) ABSTRACT

A wide mouth carryout bag includes a front wall and a rear wall, each wall having a top edge, a bottom edge, first and second side edges. First and second side gusset joins the first and second side edges of the front wall to the first and second side edges of the rear wall. The first and second side gussets are folded inwardly from the first and second side edges of the front and rear walls. The bottom edge of the front wall is joined to the bottom edge of the rear wall at a bottom seal after the inward folding of the first and second side gussets. First and second angle seals extend from the first and second side edge of the walls to the bottom seal. When the wide mouth carryout bag is opened, the two angle seals will cause the bag to have a substantially flat bottom.

### FIELD OF INVENTION

This invention relates to the field of plastic and other film bags and more specifically to wide mouth bags for groceries and other merchandise.

### BACKGROUND OF THE INVENTION

Most retail establishments provide consumers with t-shirt style bags to carry out their purchases. These bags have handles on both the left and right top sides and are loaded and dispensed from stand-up wire racks. To make the handles, the front and rear walls of the bag are sealed together at the top left and right sides. As a result, the handles restrict the loading and unloading of goods into the bag, and often require the goods to be tilted to be loaded into or removed from the bag. Tilting of the goods is especially undesirable when the contents are foodstuffs, such as prepared meals, as the contents end up being mixed together.

The present invention provides for a convenient to use handle bag with a 40% larger opening for loading goods into the bag, thanks to lack of interference from the bag handles of a typical t-shirt style bag. The wide mouth carryout bag can be constructed to be free standing when open for loading and self-opening when used on a standard dispensing rack.

Some examples of merchandise carryout bags and related inventions include the following.

GB Patent No. 1594119A, issued to Suominen, discloses a plastic shopping bag provided with an integral handle portion of wave configuration having a strip of reinforcement material therein of heavier gauge plastic than the remainder of the bag. The heavier gauge strip extends across the handle portion in spaced relation to the side edges of the bag. A plurality of such bags are fabricated by providing a flattened plastic film tube which has coextensive overlapping strips of heavier gauge material on the opposite faces thereof, cutting through the tube faces along a cutting line of cyclically recurring wave configuration that extends in the direction of elongation of the heavier gauge strips, the wavelength of said wave configuration being substantially equal to the desired width of the mouth of one of said shopping bags and the amplitude of said wave configuration being greater than the widths of said heavier gauge strips whereby the crests of the wave configuration are located at positions outside the boundary edges of the heavier gauge strips, and thereafter cutting the two faces along transverse seam lines which extend from the wave configuration crests to the outer edges of the flat tube of plastic film material

BE Patent No. 1017045A6, issued to Laureyssens is directed to a method of production and implementation of a carrier bag for transporting all kinds of objects, which has at least three carrying handles. As a result, the weight of the object is better distributed over the whole bearing surface of the bag so there is less chance that the surface tears in overweight conditions. Highly desirable, this carrying case is fitted with four lugs. For example, a version with three handles is possible for a paper bag with rope handles.

CN Patent No. 202276941U, issued to Liu Jun illustrates a bamboo shopping bag with environmental protection, beautification, large bearing and easy cleaning characteristics. The utility model comprises a bag body, which is characterized in that the bag body is prepared from folded composite bamboo boards in a U shape. The bag body is provided with a handle mouth and a through aperture. Double sides of the bag body pass through the through aperture using a rope for forming a side surface storage barrier on the bag body. The utility model employs renewable fast-growing resource bamboo wood, which has the advantages of beautification and manufacturability, continuous usage, and self-degradation in nature after waste without environmental pollution.

DE Patent No. 10116920A1, issued to Meyer is directed to a plastic film bag. It includes two side walls, the two side edges of which are welded together. The two side walls in each case are formed from a position of a double-layer plastic film web that is separated off. Preferably the two plies are placed one on top of another by folding of a double web, so that the closed bottom of the carrying bag of the folded web is formed. In the present embodiment the base is located in an additional folding, the so-called bottom fold. At the upper end of each side wall below the open mouth, in each case a backing sheet is fastened on the respective side wall. Preference is given to the two reinforcing tabs fastened in each case on the inside of the side wall. A fastening to the outside is also possible, however, in the manufacture of complex. The reinforcing tabs on the respective side wall are glued or welded thereto, they are preferably glued—with a hot melt adhesive.

KR Patent No. 100868796B1, issued to Ryu is directed to a handle for a shopping bag that is provided to seal the top of the shopping bag for the content in the shopping bag not to be seen from the outside. A handle of the shopping bag comprises: a band part; a hanging piece which is formed in both ends of the band part and is inserted into the combining hole. The handle hangs at the edge of the combining hole and prevents separation from the shopping bag. A cover which is formed in the single-side of the band part and shields the bonding groove and a combining unit which is formed at the first and the second band parts, prevents the inside of the shopping bag from being seen, and cross-couples the first and the second band parts.

It is an objective of the present invention to provide a bag dispensing and loading system that provides film bags that are easier to load and unload. It is a further objective to provide a system that is compact and fits the form factor for a standard t-shirt style bag while providing easier loading and unloading. It is a still further objective of the invention to provide a dispensing and loading system that uses free standing bags. It is yet a further objective to provide such a system that uses self-opening bags. Finally, it is an objective of the present invention to provide a bag dispensing and loading system that is durable, inexpensive, easy to keep clean and simple to use.

While some of the objectives of the present invention are disclosed in the prior art, none of the inventions found include all of the requirements identified.

### SUMMARY OF THE INVENTION

The present invention addresses all of the deficiencies of prior art wide mouth carryout bags and satisfies all of the objectives described above.

(1) A wide mouth carryout bag providing the desired features may be constructed from the following components. A front wall is provided. The front wall has a top edge, a bottom edge, first and second side edges. A rear wall is provided. The rear wall has a top edge, a bottom edge, first and second side edges. A first side gusset is provided. The first side gusset joins the first side edge of the front wall to the first side edge of the rear wall. A second side gusset is provided. The second side gusset joins the second side edge of the front wall to the second side edge of the rear wall. The first and second side gussets are folded inwardly from the first and second side edges of the front and rear walls. The bottom edge of the front wall is joined to the bottom edge of the rear wall at a bottom seal after the inward folding of the first and second side gussets. A handle opening is provided. The handle opening penetrates the front and rear walls at a point adjacent the top edges of the front and rear walls.

(2) In a variant of the invention, a first angle seal is provided. The first angle seal extends from the first side edge of the front and rear walls to the bottom seal at a point spaced outwardly from an innermost portion of the first side gusset. A second angle seal is provided. The second angle seal extends from the second side edge of the front and rear walls to the bottom seal at a point spaced outwardly from an innermost portion of the second side gusset. When the wide mouth carryout bag is opened, the first and second angle seals will cause the bag to have a substantially flat bottom.

(3) In another variant, the top edges of the front and rear walls are cut in a wave form.

(4) In still another variant, a first dispenser arm mounting aperture is provided. The first aperture penetrates the front and rear walls and the first side gusset adjacent the first side edge and the top edges of the front and rear walls. A second dispenser arm mounting aperture is provided. The second aperture penetrates the front and rear walls and the second side gusset adjacent the second side edge and the top edges of the front and rear walls.

(5) In yet another variant, a central mounting tab is provided. The central mounting tab has at least one mounting opening. The opening is sized and shaped to fit slidably over a central dispenser rack mounting hook. The central mounting tab is frangibly attached to the top edges of the front and rear walls above the handle opening.

(6) In a further variant, an alignment feature is provided. The alignment feature fastens the central mounting tab to a subsequent central mounting tab in a bag stack, thereby permitting easy mounting of the central mounting tabs to a dispensing rack.

(7) In still a further variant, the alignment feature is selected from the group that includes proprietary bag material formulations, hot pinning, cold staking, glue spotting, knife cutting, adhesive inks and corona treatment with pressure.

(8) In still a further variant, a central, frangible mounting opening is provided. The central, frangible mounting opening is centrally located in the front and rear walls adjacent the top edges of the front and rear walls. The mounting opening is adapted to break apart with sufficient pressure from a force of removing the wide mouth carryout bag from a dispensing rack. The frangible mounting opening remains with the bag when dispensed.

(9) In yet a further variant, at least one self-opening feature selected from the group that includes proprietary bag material formulations, hot pinning, cold staking, glue spotting, knife cutting, adhesive inks and corona treatment with pressure is provided.

(10) In another variant of the invention, the proprietary bag material formulations include 0.5 wt. % slip and antiblock compound.

(11) In still another variant, the proprietary bag material formulations include 1-3 wt. % calcium carbonate.

(12) In yet another variant, the proprietary bag material formulations include 10-20 wt. % recycled material, said recycled material comprising about 40-49 wt. % high density, high molecular weight polyethylene, 12-20 wt. % high density, medium molecular weight polyethylene, 20-30 wt. % linear low density polyethylene, 0-8 wt. % color concentrate.

(13) In a further variant, 10-15 wt. % of the linear low density polyethylene has a density ranging from .923-.924 gm/cc.

(14) In still a further variant, 10-15 wt. % of the linear low density polyethylene has a melt index ranging from .25-.30 gm/10 minutes.

(15) In yet a further variant, the high density, medium molecular weight polyethylene has a density ranging from .937-.947 gm/cc.

(16) In another variant of the invention, the high density, medium molecular weight polyethylene has a melt index ranging from .10-.30 gm/10 minutes.

(17) In still another variant of the invention, the at least one self-opening feature is located adjacent the top edges of the front and rear bag walls.

(18) In yet another variant, the at least one self-opening feature is located below the first and second dispenser arm mounting apertures.

(19) In a further variant, the handle opening is of the form selected from the group that includes round, oval, racetrack and kidney shaped.

(20) In still a further variant, a dispensing rack is provided. The dispensing rack includes a base. The base is sized to accommodate a fully open wide mouth carryout bag. A central dispenser rack mounting hook is provided. The central mounting hook is attached to a central support extending upwardly from the base. The central support is adapted to position a stack of wide mouth carryout bags above the base using the central mounting tab or the central, frangible mounting opening. First and second side mounting arms are provided. The first and second side mounting arms are attached to the central support. The first and second side mounting arms are adapted to engage the first and second dispenser arm mounting apertures, position a stack of wide mouth carryout bags above the base and to maintain the bags in an open position for loading.

(21) A method of making a wide mouth carryout bag, includes the steps of: extruding a tube of flexible film material; folding in first and second side gussets; flattening the tube; die cutting a bag mouth orthogonal to a length of the tube; forming a bottom seal orthogonal to the length of the tube, the bottom seal spaced from the bag mouth by a first predetermined distance, thereby forming the wide mouth carryout bag; cutting the bag from the flattened tube at a point below the bottom seal; stacking the bags with the bag mouths aligned.

(22) A variant of the method further includes the steps of: Forming a first angle seal, the first angle seal extends from the first side edge of the front and rear walls to the bottom seal at a point spaced outwardly from an innermost portion of the first side gusset; and forming a second angle seal, the second angle seal extends from the second side edge of the front and rear walls to the bottom seal at a point spaced outwardly from an innermost portion of the second side gusset.

(23) Another variant of the method further comprises the step of forming the bag mouth with the top edges of the front and rear walls cut in a wave form.

(24) Still another variant of the method further comprises the steps of: Forming a first dispenser arm mounting aperture. The first aperture penetrates the front and rear walls and the first side gusset adjacent the first side edge and the top edges of the front and rear walls. Forming a second dispenser arm mounting aperture. The second aperture penetrates the front and rear walls and the second side gusset adjacent the second side edge and the top edges of the front and rear walls.

(25) Yet another variant of the method further comprises the steps of: Forming a central mounting tab, the central mounting tab has at least one mounting opening, the opening is sized and shaped to fit slidably over a central dispenser rack mounting hook. Frangibly attaching the central mounting tab to the top edges of the front and rear walls.

(26) A further variant of the method of making a wide mouth carryout bag further includes the step of providing an alignment feature. The alignment feature fastens the central mounting tab to a subsequent central mounting tab in a bag stack, thereby permitting easy mounting of said central mounting tabs to a dispensing rack.

(27) Still a further variant of the method of making a wide mouth carryout bag the alignment feature is selected from the group comprising proprietary bag material formulations, hot pinning, cold staking, glue spotting, knife cutting, adhesive inks and corona treatment with pressure.

(28) Yet a further variant of the method includes the step of: forming a central, frangible mounting opening, the central, frangible mounting opening is centrally located in the front and rear walls adjacent the top edges of the front and rear walls. The central, frangible mounting opening is adapted to break apart with sufficient pressure from a force of removing the wide mouth carryout bag from a dispensing rack, the frangible mounting opening remaining with the bag when dispensed.

(29) Another variant of the method includes the step of adding at least one self-opening feature to the bags.

(30) Still another variant of the method includes the step of selecting the at least one self-opening feature from the group that includes: proprietary bag material formulations, hot pinning, cold staking, glue spotting, knife cutting, adhesive inks and corona treatment with pressure.

(31) In yet another variant of the method of making a wide mouth carryout bag the proprietary bag material formulation includes 0.5 wt. % slip and antiblock compound.

(32) In a further variant of the method of making a wide mouth carryout bag, the proprietary bag material formulations include 1-3 wt. % calcium carbonate.

(33) In still a further variant, the method of making a wide mouth carryout bag the proprietary bag material formulations include 10-20 wt. % recycled material, said recycled material comprising about 40-49 wt. % high density, high molecular weight polyethylene, 12-20 wt. % high density, medium molecular weight polyethylene, 20-30 wt. % linear low density polyethylene, 0-8 wt. % color concentrate.

(34) In yet a further variant, 10-15 wt. % of said linear low density polyethylene has a density ranging from .923-.924 gm/cc.

(35) In another variant, 10-15 wt. % of said linear low density polyethylene has a melt index ranging from .25-.30 gm/10 minutes.

(36) In still another variant, the high density, medium molecular weight polyethylene has a density ranging from .937-.947 gm/cc.

(37) In yet another variant, the high density, medium molecular weight polyethylene has a melt index ranging from .10-.30 gm/10 minutes.

(38) Another variant of the method further includes the step of locating the at least one self-opening feature adjacent the top edges of the front and rear bag walls.

(39) Still another variant of the method includes the step of locating the at least one self-opening feature below the first and second dispenser arm mounting apertures.

(40) A final variant of the method further includes the step of die cutting a handle opening. The handle opening penetrates the front wall and the rear wall. The handle opening is of the form selected from the group that includes round, oval, racetrack and kidney shaped.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of the preferred embodiment of the invention mounted on a dispensing rack;

FIG. 2 is a plan view of the FIG. 1 embodiment illustrating the detachable central mounting tab, side mounting apertures bottom and angle seals and self-opening features;

FIG. 2A is a plan view of the FIG. 1 embodiment without angle seals;

FIG. 3 is a plan view of the FIG. 1 embodiment illustrating a racetrack handle opening;

FIG. 4 is a plan view of the FIG. 1 embodiment illustrating an oval handle opening;

FIG. 5 is a plan view of the FIG. 1 embodiment illustrating an elliptical handle opening;

FIG. 6 is a plan view of the FIG. 1 embodiment illustrating a flat bottom oval handle opening and adhesive ink printing on the bag surface;

FIG. 7 is perspective view of the lower portion of the bag illustrating the angle seal prior to opening;

FIG. 8 is perspective view of the lower portion of the bag illustrating the angle seal partially opened;

FIG. 9 is perspective view of the lower portion of the bag illustrating the angle seal further opened to form a flat-bottomed bag;

FIG. 10 is perspective view of the lower portion of the bag illustrating the angle seal fully open and the flat bottom formed;

FIG. 11 is a perspective view illustrating the formation of the angle seals after the formation of the bottom seal;

FIG. 12 is a perspective view illustrating corona treatment and pressure point application to add self-opening capability;

FIG. 13 is a perspective view illustrating die cutting of the bag mouth for bags with detachable central mounting tab;

FIG. 14 a perspective view of the finished bag stack of bags with detachable central mounting tab;

FIG. 15 is a perspective view illustrating die cutting of the bag mouth for bags with a central, frangible mounting opening; and

FIG. 16 a perspective view of the finished bag stack of bags with a central, frangible mounting opening.

### DETAILED DESCRIPTION OF THE PREFERRED EMBODIMENT

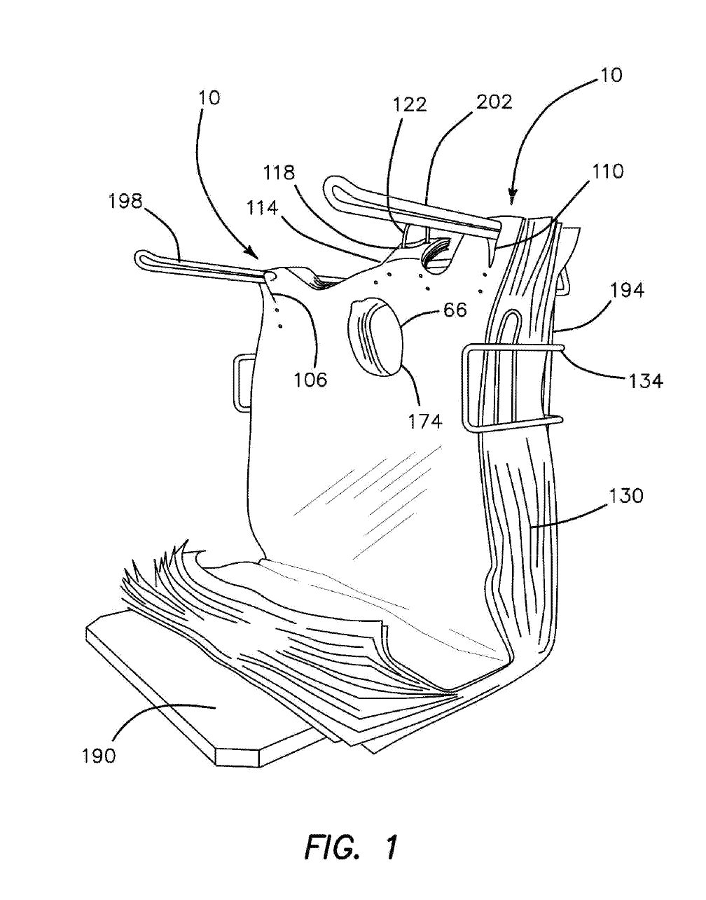

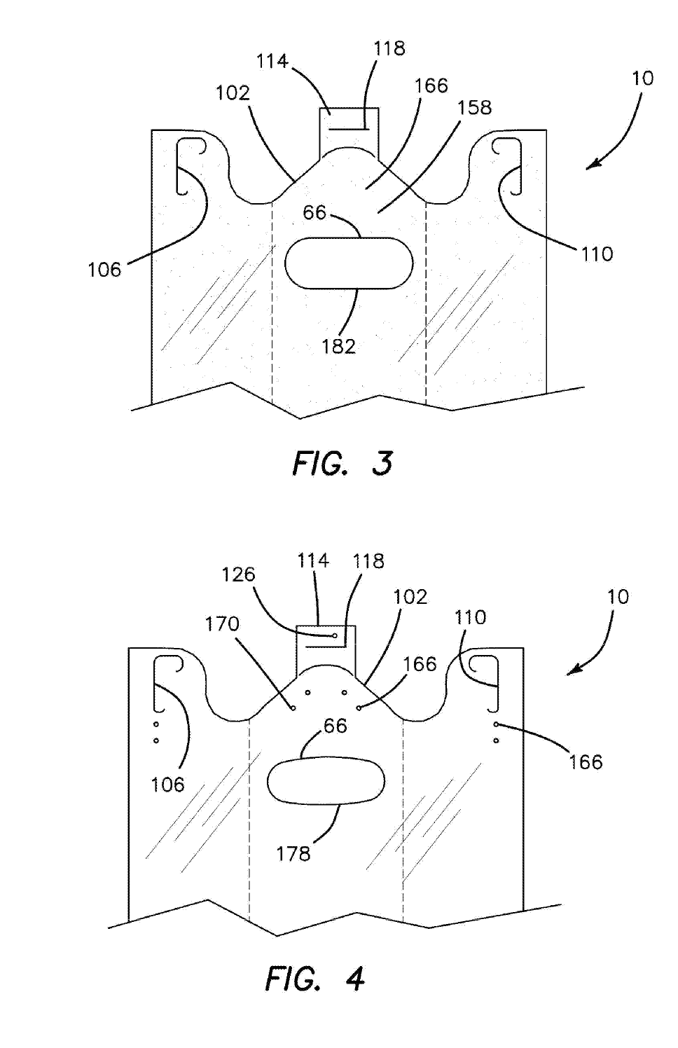

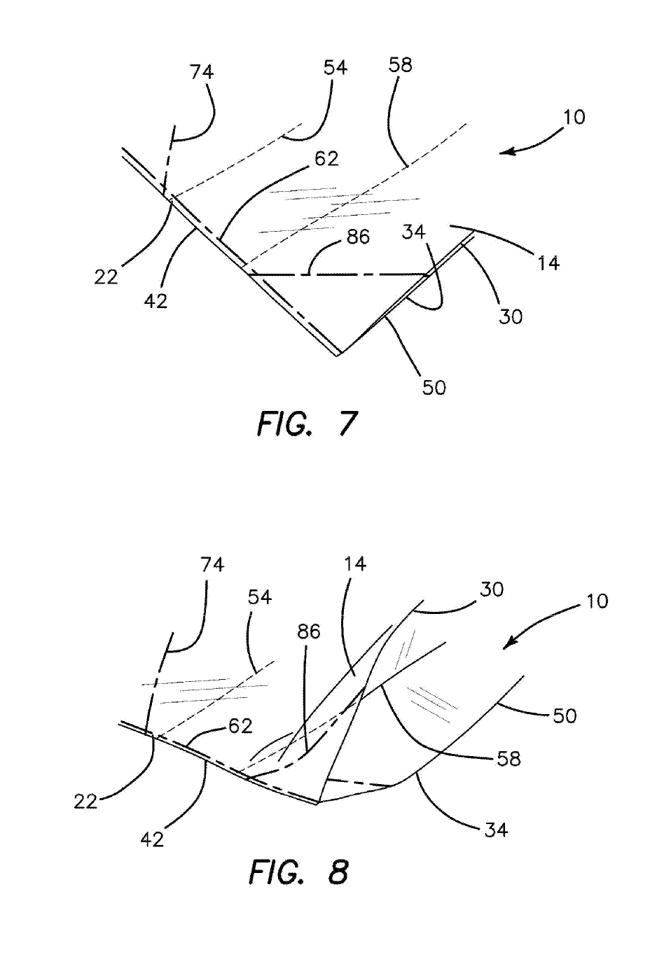

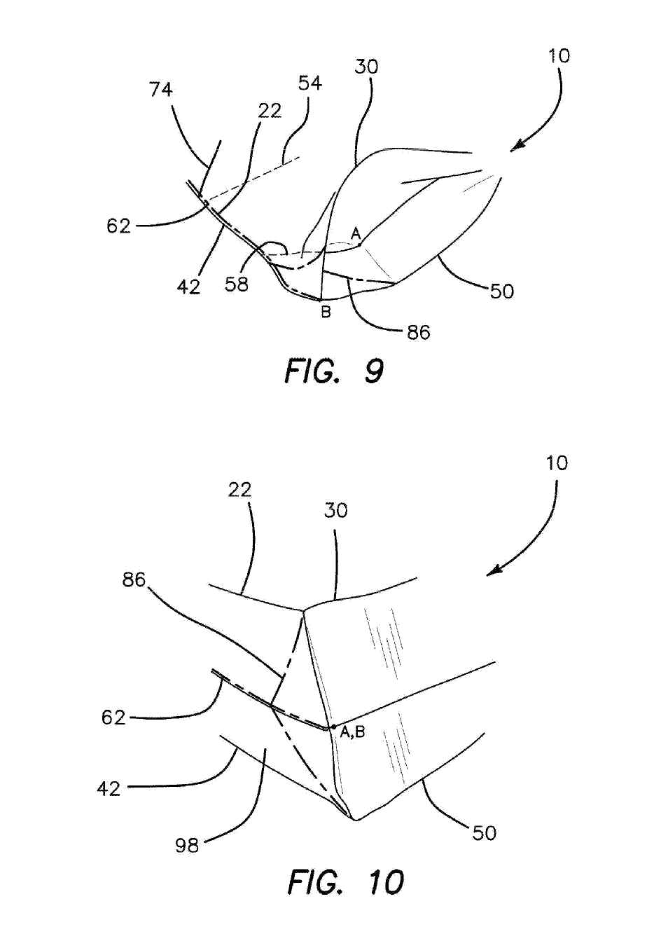

(1) FIGS. 1-10 illustrate a wide mouth carryout bag 10 providing the desired features that may be constructed from the following components. A front wall 14 is provided. The front wall 14 has a top edge 18, a bottom edge 22, first 26 and second 30 side edges. A rear wall 34 is provided. The rear wall 34 has a top edge 38, a bottom edge 42, first 46 and second 50 side edges. A first side gusset 54 is provided. The first side gusset 54 joins the first side edge 26 of the front wall 14 to the first side edge 46 of the rear wall 34. A second side gusset 58 is provided. The second side gusset 58 joins the second side edge 30 of the front wall 14 to the second side edge 50 of the rear wall 34. The first 54 and second 58 side gussets are folded inwardly from the first 26, 46 and second 30, 50 side edges of the front 14 and rear 34 walls. The bottom edge 22 of the front wall 14 is joined to the bottom edge 42 of the rear wall 34 at a bottom seal 62 after the inward folding of the first 54 and second 58 side gussets. A handle opening 66 is provided. The handle opening 66 penetrates the front 14 and rear 34 walls at a point 70 adjacent the top edges 18, 38 of the front 14 and rear 34 walls.

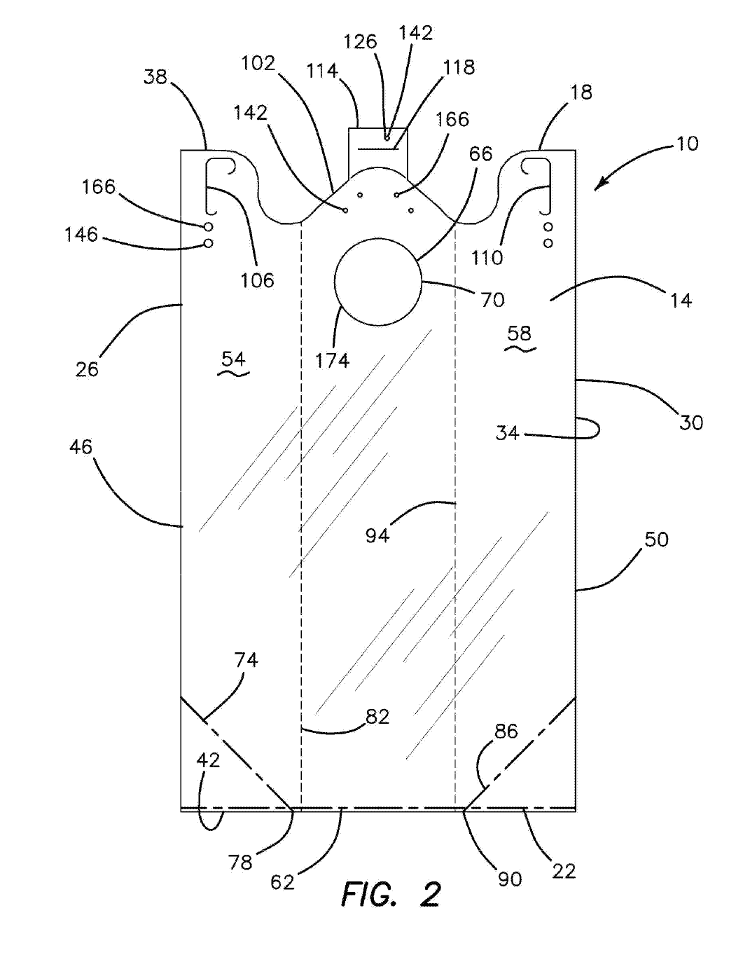

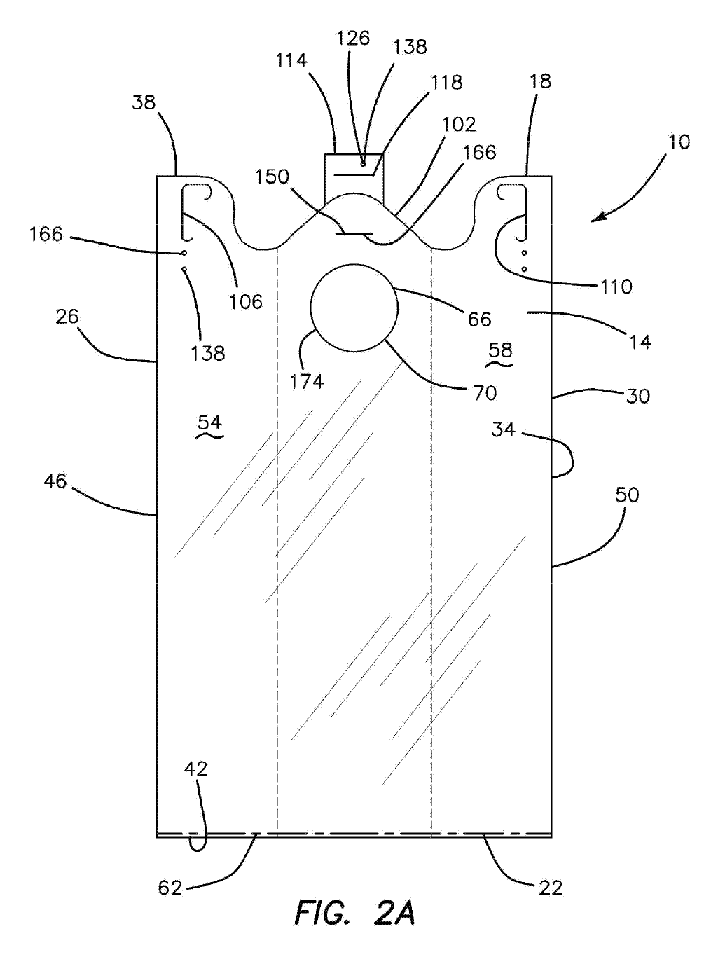

(2) In a variant of the invention, as illustrated in FIGS. 2 and 7-10, a first angle seal 74 is provided. The first angle seal 74 extends from the first side edge 26, 46 of the front 14 and rear 34 walls to the bottom seal 62 at a point 78 spaced outwardly from an innermost portion 82 of the first side gusset 54. A second angle seal 86 is provided. The second angle seal 86 extends from the second side edge 30, 50 of the front 14 and rear 34 walls to the bottom seal 62 at a point 90 spaced outwardly from an innermost portion 94 of the second side gusset 58. When the wide mouth carryout bag 10 is opened, the first 74 and second 86 angle seals will cause the bag 10 to have a substantially flat bottom 98.

(3) In another variant, as illustrated in FIGS. 1-6, 14 and 16, the top edges 18, 38 of the front 14 and rear 34 walls are cut in a wave form 102.

(4) In still another variant, a first dispenser arm mounting aperture 106 is provided. The first aperture 106 penetrates the front 14 and rear 34 walls and the first side gusset 54 adjacent the first side edge 26, 46 and the top edges 18, 38 of the front 14 and rear 34 walls. A second dispenser arm mounting aperture 110 is provided. The second aperture 110 penetrates the front 14 and rear 34 walls and the second side gusset 58 adjacent the second side edge 30, 50 and the top edges 18, 38 of the front 14 and rear 34 walls.

(5) In yet another variant, as illustrated in FIGS. 1-4, 6 and 14, a central mounting tab 114 is provided. The central mounting tab 114 has at least one mounting opening 118. The opening 118 is sized and shaped to fit slidably over a central dispenser rack mounting hook 122. The central mounting tab 114 is frangibly attached to the top edges 18, 38 of the front 14 and rear 34 walls above the handle opening 66.

(6) In a further variant, an alignment feature 126 is provided. The alignment feature 126 fastens the central mounting tab 114 to a subsequent central mounting tab 114 in a bag stack 130, thereby permitting easy mounting of the central mounting tabs 114 to a dispensing rack 134.

(7) In still a further variant, the alignment feature 126 is selected from the group that includes proprietary bag material formulations 170, hot pinning 138, cold staking 142, glue spotting 146, knife cutting 150, adhesive inks 154 and corona treatment with pressure 158.

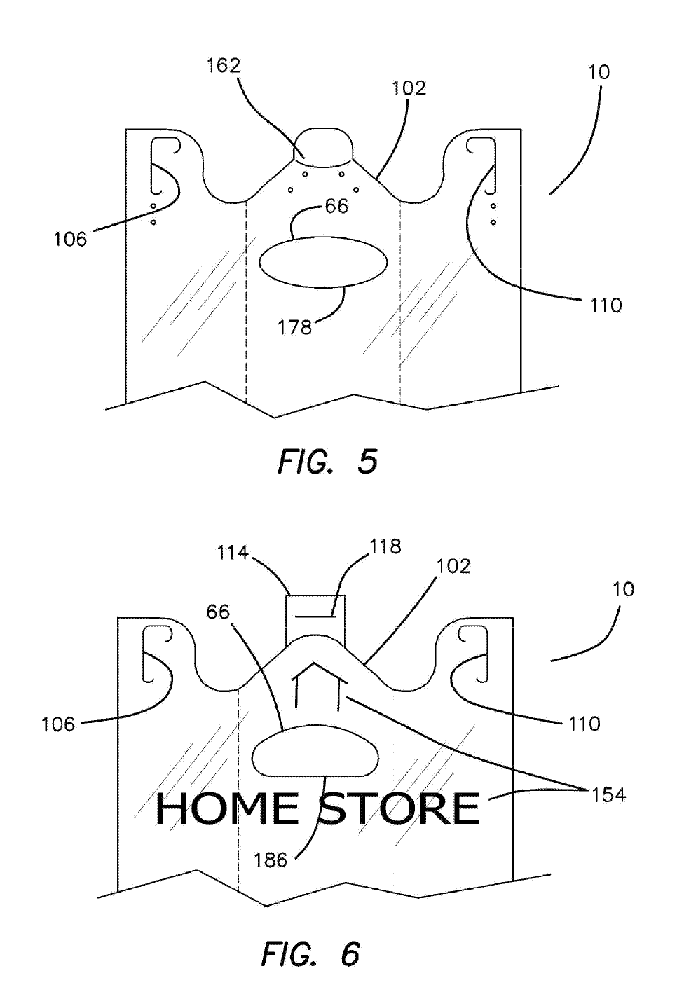

(8) In still a further variant, as illustrated in FIGS. 5 and 16, a central, frangible mounting opening 162 is provided. The central, frangible mounting opening 162 is centrally located in the front 14 and rear 34 walls adjacent the top edges 18, 38 of the front 14 and rear 34 walls. The mounting opening 162 is adapted to break apart with sufficient pressure from a force of removing the wide mouth carryout bag 10 from a dispensing rack 134. The frangible mounting opening 162 remains with the bag 10 when dispensed.

(9) In yet a further variant, as illustrated in FIGS. 1-6 and 12-16, at least one self-opening feature 166 selected from the group that includes proprietary bag material formulations 170, hot pinning 138, cold staking 142, glue spotting 146, knife cutting 150, adhesive inks 154 and corona treatment with pressure 158 is provided.

(10) In another variant of the invention, the proprietary bag material formulations 170 include 0.5 wt. % slip and antiblock compound.

(11) In still another variant, the proprietary bag material formulations 170 include 1-3 wt. % calcium carbonate.

(12) In yet another variant, the proprietary bag material formulations 170 include 10-20 wt. % recycled material, said recycled material comprising about 40-49 wt. % high density, high molecular weight polyethylene, 12-20 wt. % high density, medium molecular weight polyethylene, 20-30 wt. % linear low density polyethylene, 0-8 wt. % color concentrate.

(13) In a further variant, 10-15 wt. % of the linear low density polyethylene has a density ranging from .923-.924 gm/cc.

(14) In still a further variant, 10-15 wt. % of the linear low density polyethylene has a melt index ranging from .25-.30 gm/10 minutes.

(15) In yet a further variant, the high density, medium molecular weight polyethylene has a density ranging from .937-.947 gm/cc.

(16) In another variant of the invention, the high density, medium molecular weight polyethylene has a melt index ranging from .10-.30 gm/10 minutes.

(17) In still another variant of the invention, as illustrated in FIGS. 1, 2, 2A, 4, 5 and 12-16, the at least one self-opening feature 166 is located adjacent the top edges 18, 38 of the front 14 and rear 34 bag walls.

(18) In still another variant, as illustrated in FIGS. 1, 2, 2A, 4, 5 and 12-16, the at least one self-opening feature 166 is located below the first 106 and second 110 dispenser arm mounting apertures.

(19) In yet another variant, as illustrated in FIGS. 1-6, 14 and 16, the handle opening 66 is of the form selected from the group that includes round 174, oval 178, racetrack 182 and kidney shaped 186.

(20) In a further variant, as illustrated in FIG. 1, a dispensing rack 134 is provided. The dispensing rack 134 includes a base 190. The base 190 is sized to accommodate a fully open wide mouth carryout bag 10. A central dispenser rack mounting hook 122 is provided. The central mounting hook 122 is attached to a central support 194 extending upwardly from the base 190. The central support 194 is adapted to position a stack 130 of wide mouth carryout bags 10 above the base 190 using the central mounting tab 114 or the central, frangible mounting opening 162. First 198 and second 202 side mounting arms are provided. The first 198 and second 202 side mounting arms are attached to the central support 194. The first 198 and second 202 side mounting arms are adapted to engage the first 106 and second 110 dispenser arm mounting apertures, position a stack 130 of wide mouth carryout bags 10 above the base 190 and to maintain the bags 10 in an open position 206 for loading.

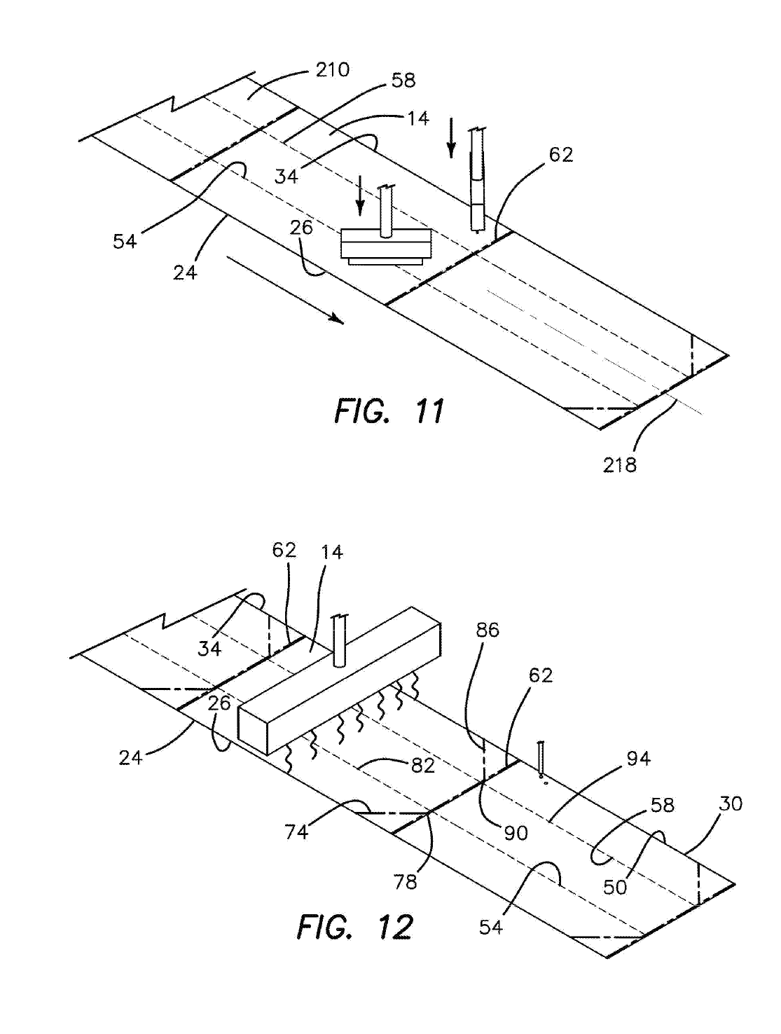

(21) A method of making a wide mouth carryout bag 10, as illustrated in FIGS. 11-16, includes the steps of: extruding a tube of flexible film material 210; folding in first 54 and second 58 side gussets; flattening the tube 210; die cutting a bag mouth 214 orthogonal to a length 218 of the tube 210; forming a bottom seal 62 orthogonal to the length 218 of the tube 210, the bottom seal 62 spaced from the bag mouth 214 by a first predetermined distance 222, thereby forming the wide mouth carryout bag 10; cutting the bag 10 from the flattened tube 210 at a point 226 below the bottom seal 62; stacking the bags 10 with the bag mouths 214 aligned.

(22) A variant of the method, as illustrated in FIG. 11, further includes the steps of: forming a first angle seal 74, the first angle seal 74 extends from the first side edge 24, 26 of the front 14 and 34 rear walls to the bottom seal 62 at a point 78 spaced outwardly from an innermost portion 82 of the first side gusset 54; and forming a second angle seal 86, the second angle seal 86 extends from the second side edge 30, 50 of the front 14 and rear 34 walls to the bottom seal 62 at a point 90 spaced outwardly from an innermost portion 94 of the second side gusset 58. When the wide mouth carryout bag 10 is opened, the first 74 and second 86 angle seals will cause the bag 10 to have a substantially flat bottom 98.

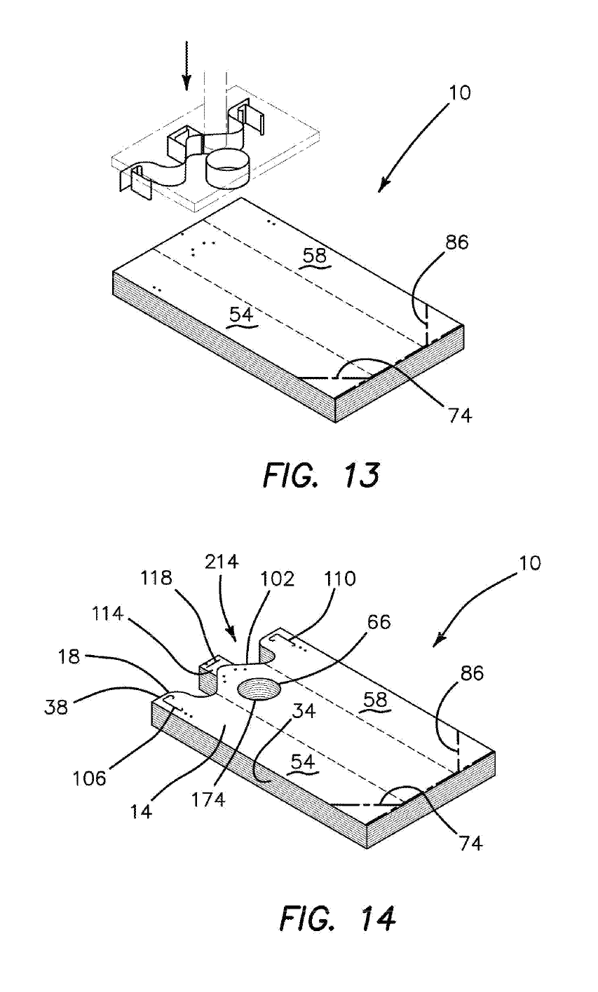

(23) Another variant of the method, as illustrated in FIGS. 13-16, further comprises the step of forming the bag mouth 214 with the top edges 18, 38 of the front 14 and rear 34 walls cut in a wave form 102.

(24) Still another variant of the method further comprises the steps of: Forming a first dispenser arm mounting aperture 106. The first aperture 106 penetrates the front 14 and rear 34 walls and the first side gusset 54 adjacent the first side edge 24, 46 and the top edges 18, 38 of the front 14 and rear 34 walls; forming a second dispenser arm mounting aperture 110. The second aperture 110 penetrates the front 14 and rear 34 walls and the second side gusset 58 adjacent the second side edge 30, 50 and the top edges 18, 38 of the front 14 and rear 34 walls.

(25) Yet another variant of the method, as illustrated in FIGS. 13 and 14, further comprises the steps of: forming a central mounting tab 114, the central mounting tab 114 has at least one mounting opening 118, the opening 118 is sized and shaped to fit slidably over a central dispenser rack mounting hook 122; frangibly attaching the central mounting tab 114 to the top edges 18, 38 of the front 14 and rear 34 walls.

(26) A further variant of the method of making a wide mouth carryout bag 10 further includes the step of providing an alignment feature 126. The alignment feature 126 fastens the central mounting tab 114 to a subsequent central mounting tab 114 in a bag stack 130, thereby permitting easy mounting of said central mounting tabs 114 to a dispensing rack 134.

(27) Still a further variant of the method of making a wide mouth carryout bag 10 the alignment feature 126 is selected from the group that includes proprietary bag material formulations 170, hot pinning 138, cold staking 142, glue spotting 146, knife cutting 150, adhesive inks 154 and corona treatment with pressure 158.

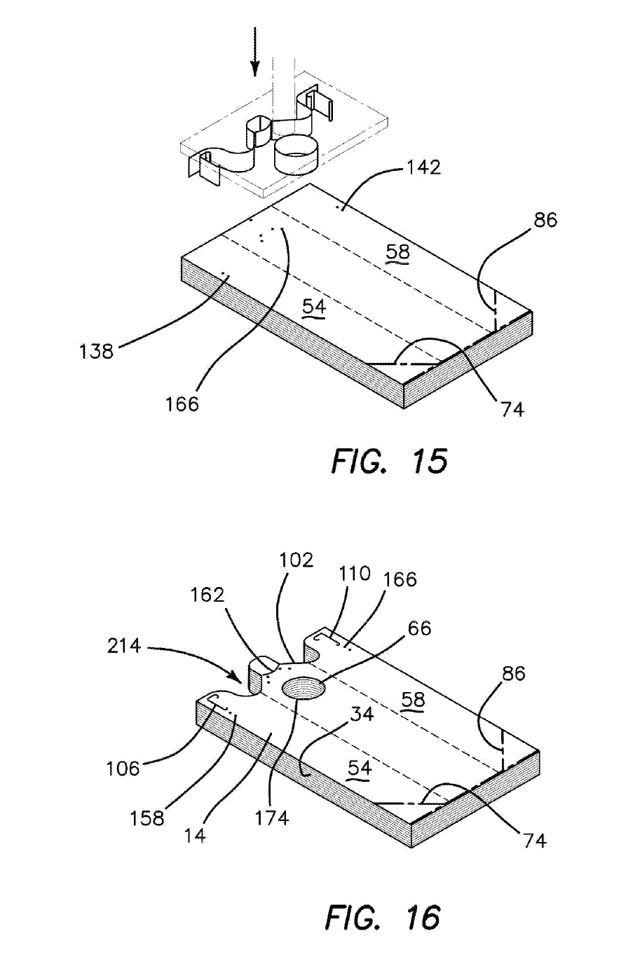

(28) A further variant of the method, as illustrated in FIGS. 15 and 16, includes the step of: forming a central, frangible mounting opening 162, the central, frangible mounting opening 162 is centrally located in the front 14 and rear 34 walls adjacent the top edges 18, 34 of the front 14 and rear 34 walls. The central, frangible mounting opening 162 is adapted to break apart with sufficient pressure from a force of removing the wide mouth carryout bag 10 from a dispensing rack 134, the frangible mounting opening 162 remaining with the bag 10 when dispensed.

(29) Still a further variant of the method, as illustrated in FIG. 12, includes the step of adding at least one self-opening feature 166 to the bags 10.

(30) Yet a further variant of the method, as illustrated in FIGS. 1-6 and 12-16, includes the step of selecting the at least one self-opening feature 166 from the group that includes: proprietary bag material formulations 170, hot pinning 138, cold staking 142, glue spotting 146, knife cutting 150, adhesive inks 154 and corona treatment with pressure 158.

(31) In yet another variant of the method of making a wide mouth carryout bag 10 the proprietary bag material formulations 170 include 0.5 wt. % slip and antiblock compound.

(32) In a further variant of the method of making a wide mouth carryout bag, the proprietary bag material formulations 170 include 1-3 wt. % calcium carbonate.

(33) In still a further variant, the method of making a wide mouth carryout bag 10 the proprietary bag material formulations 170 include 10-20 wt. % recycled material, said recycled material comprising about 40-49 wt. % high density, high molecular weight polyethylene, 12-20 wt. % high density, medium molecular weight polyethylene, 20-30 wt. % linear low density polyethylene, 0-8 wt. % color concentrate.

(34) In yet a further variant, 10-15 wt. % of said linear low density polyethylene has a density ranging from .923-.924 gm/cc. (35) In another variant, 10-15 wt. % of said linear low density polyethylene has a melt index ranging from .25-.30 gm/10 minutes.

(36) In still another variant, the high density, medium molecular weight polyethylene has a density ranging from .937-.947 gm/cc.

(37) In yet another variant, the high density, medium molecular weight polyethylene has a melt index ranging from .10-.30 gm/10 minutes.

(38) Another variant of the method, as illustrated in FIGS. 1, 2, 2A, 4, 5 and 12-16, further includes the step of locating the at least one self-opening feature 166 adjacent the top edges 18, 38 of the front 14 and rear 34 bag walls.

(39) Still another variant of the method, as illustrated in FIGS. 1, 2, 2A, 4, 5 and 12-16, includes the step of locating the at least one self-opening feature 166 below the first 106 and second 110 dispenser arm mounting apertures.

(40) A final variant of the method, as illustrated in FIGS. 1-6, 14 and 16, further includes the step of die cutting a handle opening 66. The handle opening 66 penetrates the front wall 14 and the rear wall 34. The handle opening 66 is of the form selected from the group that includes round 174, oval 178, racetrack 182 and kidney shaped 186.

The wide mouth carryout bag 10 has been described with reference to particular embodiments. Other modifications and enhancements can be made without departing from the spirit and scope of the claims that follow.

1. A wide mouth carryout bag comprising:
a front wall, said front wall having a top edge, a bottom edge, first and second side edges;
a rear wall, said rear wall having a top edge, a bottom edge, first and second side edges;
a first side gusset, said first side gusset joining said first side edge of said front wall to said first side edge of said rear wall;
a second side gusset, said second side gusset joining said second side edge of said front wall to said second side edge of said rear wall;
said first and second side gussets being folded inwardly from said first and second side edges of said front and rear walls;
said bottom edge of said front wall being joined to said bottom edge of said rear wall at a bottom seal after said inward folding of said first and second side gussets; and
a handle opening, said handle opening penetrating said front and rear walls at a point adjacent top edges of said front and rear walls;

2. The wide mouth carryout bag, as described in claim 1, further comprising:
a first angle seal, said first angle seal extending from said first side edge of said front and rear walls to said bottom seal at a point spaced outwardly from an innermost portion of said first side gusset;
a second angle seal, said second angle seal extending from said second side edge of said front and rear walls to said bottom seal at a point spaced outwardly from an innermost portion of said second side gusset; and
whereby, when said wide mouth carryout bag is opened, said first and second angle seals will cause said bag to have a substantially flat bottom.

3. The wide mouth carryout bag, as described in claim 1 or 2, wherein said top edges of said front and rear walls are cut in a wave form.

4. The wide mouth carryout bag, as described in claim 1 or 2, further comprising:
a first dispenser arm mounting aperture, said first aperture penetrating said front and rear walls and said first side gusset adjacent said first side edge and said top edges of said front and rear walls; and
a second dispenser arm mounting aperture, said second aperture penetrating said front and rear walls and said second side gusset adjacent said second side edge and said top edges of said front and rear walls.

5. The wide mouth carryout bag, as described in claim 4, further comprising:
a central mounting tab, said central mounting tab having at least one mounting opening, said opening being sized and shaped to fit slidably over a central dispenser rack mounting hook; and
said central mounting tab being frangibly attached to said top edges of said front and rear walls above said handle opening.

6. The wide mouth carryout bag, as described in claim 5, further comprising an alignment feature, said alignment feature fastening said central mounting tab to a subsequent central mounting tab in a bag stack, thereby permitting easy mounting of said central mounting tabs to a dispensing rack.

7. The wide mouth carryout bag, as described in claim 6, wherein said alignment feature is selected from the group comprising:
bag material formulations proprietary, hot pinning, cold staking, glue spotting, knife cutting, adhesive inks and corona treatment with pressure.

8. The wide mouth carryout bag, as described in claim 4, further comprising a central, frangible mounting opening, said central, frangible mounting opening being centrally disposed in said front and rear walls adjacent said top edges of said front and rear walls and being adapted to break apart with sufficient pressure from a force of removing said wide mouth carryout bag from a dispensing rack, said frangible mounting opening remaining with said bag when dispensed.

9. The wide mouth carryout bag, as described in claim 5, further comprising at least one self-opening feature selected from the group comprising:
proprietary bag material formulations, hot pinning, cold staking, glue spotting, knife cutting, adhesive inks and corona treatment with pressure.

10. The wide mouth carryout bag, as described in claim 8, further comprising at least one self-opening feature selected from the group comprising:
proprietary bag material formulations, hot pinning, cold staking, glue spotting, knife cutting, adhesive inks and corona treatment with pressure.

11. The wide mouth carryout bag, as described in claim 7, wherein the proprietary bag material formulations comprise 0.5 wt. % slip and antiblock compound.

12. The wide mouth carryout bag, as described in claim 9, wherein the proprietary bag material formulations comprise 0.5 wt. % slip and antiblock compound.

13. The wide mouth carryout bag, as described in claim 10, wherein the proprietary bag material formulations comprise 0.5 wt. % slip and antiblock compound.

14. The wide mouth carryout bag, as described in claim 7, wherein the proprietary bag material formulations comprise 1-3 wt. % calcium carbonate.

15. The wide mouth carryout bag, as described in claim 9, wherein the proprietary bag material formulations comprise 1-3 wt. % calcium carbonate.

16. The wide mouth carryout bag, as described in claim 10, wherein the proprietary bag material formulations comprise 1-3 wt. % calcium carbonate.

17. The wide mouth carryout bag, as described in claim 7, wherein the proprietary bag material formulations comprise 10-20 wt. % recycled material, said recycled material comprising about 40-49 wt. % high density, high molecular weight polyethylene, 12-20 wt. % high density, medium molecular weight polyethylene, 20-30 wt. % linear low density polyethylene, 0-8 wt. % color concentrate.

18. The wide mouth carryout bag, as described in claim 9, wherein the proprietary bag material formulations comprise 10-20 wt. % recycled material, said recycled material comprising about 40-49 wt. % high density, high molecular weight polyethylene, 12-20 wt. % high density, medium molecular weight polyethylene, 20-30 wt. % linear low density polyethylene, 0-8 wt. % color concentrate.

19. The wide mouth carryout bag, as described in claim 10, wherein the proprietary bag material formulations comprise 10-20 wt. % recycled material, said recycled material comprising about 40-49 wt. % high density, high molecular weight polyethylene, 12-20 wt. % high density, medium molecular weight polyethylene, 20-30 wt. % linear low density polyethylene, 0-8 wt. % color concentrate.

20. The wide mouth carryout bag, as described in claim 17, wherein 10-15 wt. % of said linear low density polyethylene has a density ranging from .923-.924 gm/cc.

21. The wide mouth carryout bag, as described in claim 18, wherein 10-15 wt. % of said linear low density polyethylene has a density ranging from .923-.924 gm/cc.

22. The wide mouth carryout bag, as described in claim 19, wherein 10-15 wt. % of said linear low density polyethylene has a density ranging from .923-.924 gm/cc.

23. The wide mouth carryout bag, as described in claim 17, wherein 10-15 wt. % of said linear low density polyethylene has a melt index ranging from .25-.30 gm/10 minutes.

24. The wide mouth carryout bag, as described in claim 18, wherein 10-15 wt. % of said linear low density polyethylene has a melt index ranging from .25-.30 gm/10 minutes.

25. The wide mouth carryout bag, as described in claim 19, wherein 10-15 wt. % of said linear low density polyethylene has a melt index ranging from .25-.30 gm/10 minutes.

26. The wide mouth carryout bag, as described in claim 17, wherein said high density, medium molecular weight polyethylene has a density ranging from .937-.947 gm/cc.

27. The wide mouth carryout bag, as described in claim 18, wherein said high density, medium molecular weight polyethylene has a density ranging from .937-.947 gm/cc.

28. The wide mouth carryout bag, as described in claim 19, wherein said high density, medium molecular weight polyethylene has a density ranging from .937-.947 gm/cc.

29. The wide mouth carryout bag, as described in claim 17, wherein said high density, medium molecular weight polyethylene has a melt index ranging from .10-.30 gm/10 minutes.

30. The wide mouth carryout bag, as described in claim 18, wherein said high density, medium molecular weight polyethylene has a melt index ranging from .10-.30 gm/10 minutes.

31. The wide mouth carryout bag, as described in claim 19, wherein said high density, medium molecular weight polyethylene has a melt index ranging from .10-.30 gm/10 minutes.

32. The wide mouth carryout bag, as described in claim 9, wherein said at least one self-opening feature is disposed adjacent said top edges of said front and rear bag walls.

33. The wide mouth carryout bag, as described in claim 10, wherein said at least one self-opening feature is disposed adjacent said top edges of said front and rear bag walls.

34. The wide mouth carryout bag, as described in claim 9, wherein said at least one self-opening feature is disposed below said first and second dispenser arm mounting apertures.

35. The wide mouth carryout bag, as described in claim 10, wherein said at least one self-opening feature is disposed below said first and second dispenser arm mounting apertures.

36. The wide mouth carryout bag, as described in claim 1 or 2, wherein said handle opening is of the form selected from the group comprising:
round, oval, racetrack and kidney shaped.

37. The wide mouth carryout bag, as described in claim 5, in combination with a dispensing rack, said dispensing rack comprising:
a base, said base being sized to accommodate a fully open wide mouth carryout bag;
a central dispenser rack mounting hook, said central mounting hook attached to a central support extending upwardly from said base and adapted to position a stack of wide mouth carryout bags above said base using said central mounting tab or said central, frangible mounting opening; and
first and second side mounting arms, said first and second side mounting arms being attached to said central support, said first and second side mounting arms adapted to engage said first and second dispenser arm mounting apertures, position a stack of wide mouth carryout bags above said base and to maintain said bags in an open position for loading.

38. The wide mouth carryout bag, as described in claim 8, in combination with a dispensing rack, said dispensing rack comprising:
a base, said base being sized to accommodate a fully open wide mouth carryout bag;
a central dispenser rack mounting hook, said central mounting hook attached to a central support extending upwardly from said base and adapted to position a stack of wide mouth carryout bags above said base using said central mounting tab or said central, frangible mounting opening; and
first and second side mounting arms, said first and second side mounting arms being attached to said central support, said first and second side mounting arms adapted to engage said first and second dispenser arm mounting apertures, position a stack of wide mouth carryout bags above said base and to maintain said bags in an open position for loading.

39. A method of making a wide mouth carryout bag, comprising the steps of:
extruding a tube of flexible film material;
folding in first and second side gussets;
flattening said tube;
die cutting a bag mouth orthogonal to a length of said tube;
forming a bottom seal orthogonal to said length of said tube, said bottom seal spaced from said bag mouth by a first predetermined distance, thereby forming said wide mouth carryout bag;
cutting said bag from said flattened tube at a point below said bottom seal;
stacking said bags with said bag mouths aligned.

40. The method of making a wide mouth carryout bag, as described in claim 39, further comprising the steps of:
forming a first angle seal, said first angle seal extending from said first side edge of said front and rear walls to said bottom seal at a point spaced outwardly from an innermost portion of said first side gusset; and
forming a second angle seal, said second angle seal extending from said second side edge of said front and rear walls to said bottom seal at a point spaced outwardly from an innermost portion of said second side gusset.

41. The method of making a wide mouth carryout bag, as described in claim 39 or claim 40, further comprises the step of forming said bag mouth with said top edges of said front and rear walls cut in a wave form.

42. The method of making a wide mouth carryout bag, as described in claim 39 or claim 40, further comprises the steps of:
forming a first dispenser arm mounting aperture, said first aperture penetrating said front and rear walls and said first side gusset adjacent said first side edge and said top edges of said front and rear walls; and
forming a second dispenser arm mounting aperture, said second aperture penetrating said front and rear walls and said second side gusset adjacent said second side edge and said top edges of said front and rear walls.

43. The method of making a wide mouth carryout bag, as described in claim 42, further comprises the steps of:
forming a central mounting tab, said central mounting tab having at least one mounting opening, said opening being sized and shaped to fit slidably over a central dispenser rack mounting hook; and
said central mounting tab being frangibly attached to said top edges of said front and rear walls.

44. The method of making a wide mouth carryout bag, as described in claim 43, further comprises the step of providing an alignment feature, said alignment feature fastening said central mounting tab to a subsequent central mounting tab in a bag stack, thereby permitting easy mounting of said central mounting tabs to a dispensing rack.

45. The method of making a wide mouth carryout bag, as described in claim 44 wherein said alignment feature is selected from the group comprising:
proprietary bag material formulations, hot pinning, cold staking, glue spotting, knife cutting, adhesive inks and corona treatment with pressure.

46. The method of making a wide mouth carryout bag, as described in claim 42, further comprises the step of:
forming a central, frangible mounting opening, said central, frangible mounting opening being centrally disposed in said front and rear walls adjacent said top edges of said front and rear walls;
said central, frangible mounting opening being adapted to break apart with sufficient pressure from a force of removing said wide mouth carryout bag from a dispensing rack, said frangible mounting opening remaining with said bag when dispensed.

47. The method of making a wide mouth carryout bag, as described in claim 39 or claim 40, further comprising the step of adding at least one self-opening feature to said bags.

48. The method of making a wide mouth carryout bag, as described in claim 47, wherein said at least one self-opening feature is selected from the group comprising:
proprietary bag material formulations, hot pinning, cold staking, glue spotting, knife cutting, adhesive inks and corona treatment with pressure.

49. The method of making a wide mouth carryout bag, as described in claim 45 wherein the proprietary bag material formulations comprise 0.5 wt. % slip and antiblock compound.

50. The method of making a wide mouth carryout bag, as described in claim 48 wherein the proprietary bag material formulations comprise 0.5 wt. % slip and antiblock compound.

51. The method of making a wide mouth carryout bag, as described in claim 45, wherein the proprietary bag material formulations comprise 1-3 wt. % calcium carbonate.

52. The method of making a wide mouth carryout bag, as described in claim 48, wherein the proprietary bag material formulations comprise 1-3 wt. % calcium carbonate.

53. The method of making a wide mouth carryout bag, as described in claim 45, wherein the proprietary bag material formulations comprise 10-20 wt. % recycled material, said recycled material comprising about 40-49 wt. % high density, high molecular weight polyethylene, 12-20 wt. % high density, medium molecular weight polyethylene, 20-30 wt. % linear low density polyethylene, 0-8 wt. % color concentrate.

54. The method of making a wide mouth carryout bag, as described in claim 48, wherein the proprietary bag material formulations comprise 10-20 wt. % recycled material, said recycled material comprising about 40-49 wt. % high density, high molecular weight polyethylene, 12-20 wt. % high density, medium molecular weight polyethylene, 20-30 wt. % linear low density polyethylene, 0-8 wt. % color concentrate.

55. The method of making a wide mouth carryout bag, as described in claim 53, wherein 10-15 wt. % of said linear low density polyethylene has a density ranging from .923-.924 gm/cc.

56. The method of making a wide mouth carryout bag, as described in claim 54, wherein 10-15 wt. % of said linear low density polyethylene has a density ranging from .923-.924 gm/cc.

57. The method of making a wide mouth carryout bag, as described in claim 53, wherein 10-15 wt. % of said linear low density polyethylene has a melt index ranging from .25-.30 gm/10 minutes.

58. The method of making a wide mouth carryout bag, as described in claim 54, wherein 10-15 wt. % of said linear low density polyethylene has a melt index ranging from .25-.30 gm/10 minutes.

59. The method of making a wide mouth carryout bag, as described in claim 53, wherein said high density, medium molecular weight polyethylene has a density ranging from .937-.947 gm/cc.

60. The method of making a wide mouth carryout bag, as described in claim 54, wherein said high density, medium molecular weight polyethylene has a density ranging from .937-.947 gm/cc.

61. The method of making a wide mouth carryout bag, as described in claim 53, wherein said high density, medium molecular weight polyethylene has a melt index ranging from .10-.30 gm/10 minutes.

62. The method of making a wide mouth carryout bag, as described in claim 54, wherein said high density, medium molecular weight polyethylene has a melt index ranging from .10-.30 gm/10 minutes.

63. The method of making a wide mouth carryout bag, as described in claim 47, further including the step of disposing said at least one self-opening feature adjacent said top edges of said front and rear bag walls.

64. The method of making a wide mouth carryout bag, as described in claim 47, further including the step of disposing said at least one self-opening feature below said first and second dispenser arm mounting apertures.

65. The method of making a wide mouth carryout bag, as described in claim 39 or claim 40, further comprising the step of die cutting a handle opening, said handle opening penetrating said front wall and said rear wall, wherein said handle opening is of the form selected from the group comprising:
round, oval, racetrack and kidney shaped.
